(19) United States
(12) Patent Application Publication
(10) Pub. No.: US 2004/0191420 A1
(43) Pub. Date: Sep. 30, 2004

(54) Protective coatings for microporous sheets

(76) Inventors: Brian K. Rearick, Allison Park, PA (US); M. Lisa Perrine, Allison Park, PA (US)

Correspondence Address: PPG INDUSTRIES, INC., Intellectual Property Department, One PPG Place, Pittsburgh, PA, 15272, US

(21) Appl. No.: 10/395,567

(22) Filed: Mar. 24, 2003

(51) Int. Cl. B05D 3/02; B32B 3/26

(52) U.S. Cl. 427/384; 428/304.4

(57) ABSTRACT

Microporous sheets coated with protective coatings are disclosed. The protective coatings comprise a UV absorber, and may also comprise a light stabilizer. The coated microporous sheets exhibit favorable physical properties including high QUV resistance and exterior durability. The coated microporous sheets may be used for applications such as advertising displays, banners, printed materials and sports equipment.

### FIELD OF THE INVENTION

The present invention relates to coated microporous sheets. More particularly, the invention relates to protective coatings for microporous sheets which provide improved physical properties such as increased QUV resistance and exterior durability. The coated sheets are useful for many applications such as advertising displays, banners, printed materials, sports equipment, molded articles and laminated articles.

### BACKGROUND INFORMATION

Microporous sheets comprise a matrix of thermoplastic organic polymer, particulate filler and interconnecting pores. An example of a microporous sheet comprises polyethylene and silica filler particles sold under the designation Teslin® by PPG Industries, Inc. Microporous sheets are useful in many applications such as cards, tags, labels, menus, in-mold graphics, commercial printing and specialty printing.

Conventional microporous sheets may be damaged by ultraviolet radiation. They typically have a relatively low QUV resistance on the order of up to 250 hours. Attempts have been made to extend the QUV resistance of microporous sheets by modifying the composition of the polymer matrix of such sheets. However, the incorporation of UV absorbers and antioxidants within the polymer matrix substantially increases the cost of the microporous sheets. Furthermore, modification of the polymer matrix may still not achieve the desired level of the QUV resistance properties of the microporous sheets for a particular application, e.g., the QUV resistance may be below about 750 hours.

It would be desirable to produce microporous sheets having improved QUV resistance.

### SUMMARY OF THE INVENTION

The present invention provides protective coatings for microporous sheets. The protective coatings comprise a UV absorber, and may also comprise a light stabilizer and/or an antioxidant. The protective coatings exhibit favorable physical properties when applied to microporous sheets, including high QUV resistance. The coatings may be substantially clear, or they may be pigmented. The coated microporous sheets of the present invention may be used for any suitable application and are particularly useful for outdoor applications such as on promotional banners, truck placard advertisements, billboards, sports equipment and the like.

An aspect of the present invention is to provide a microporous sheet coated with a protective coating comprising a UV absorber and binder.

Another aspect of the present invention is to provide a coated microporous sheet having a QUV resistance of at least 500 hours.

A further aspect of the present invention is to provide a method of coating a microporous sheet comprising applying a flowable UV absorbing protective coating on the microporous sheet.

These and other aspects of the present invention will be more apparent from the following description.

### BRIEF DESCRIPTION OF THE DRAWINGS

FIG. 1 is a partially schematic side view of a coated microporous sheet in accordance with an embodiment of the present invention.

FIG. 2 is a partially schematic side view of a coated microporous sheet with an additional layer in accordance with another embodiment of the present invention.

### DETAILED DESCRIPTION

The present invention provides protective coatings for microporous sheets. The protective coatings provide improved physical properties such as increased QUV resistance and good mechanical properties. The protective coatings comprise a UV absorber, a binder, and may also comprise a light stabilizer. The protective coatings may further comprise one or more antioxidant, crosslinker, solvent, ink fixative, flow, wetting, slip or mar additive, as well as any other additives standard in the art of coatings formulation.

As used herein, the term “microporous sheet” means a sheet comprising a polymer matrix and an interconnecting network of pores. The matrix of the microporous sheet may comprise a substantially water-insoluble thermoplastic organic polymer. The microporous sheets may optionally comprise filler particles.

As used herein, the term “protective coating” means a material applied to at least a portion of a microporous sheet which improves at least one physical property of the microporous sheet. The protective coating may form a surface layer on the microporous sheet and/or may penetrate at least partially into the pores of the microporous sheet to thereby coat at least a portion of the polymer matrix of the microporous sheet. The protective coating may be applied to the microporous sheet in the form of a flowable material, e.g., the coating is applied in the form of a liquid, powder, spray or the like.

The term “UV absorber” as used herein includes compositions which absorb wavelengths typically associated with polymer degradation, for example, wavelengths of from about 250 to about 400 nm. The UV absorber preferably absorbs an insignificant amount of visible light, e.g., wavelengths of from 400 to 700 nm, and is non-opacifying.

The protective coating compositions of the present invention comprise a resin or binder in which is dispersed at least one UV absorber such as benzotriazoles, triazines, oxanilides, benzophenones and the like.

Suitable benzotriazole UV absorbers include 2-(2′-hydroxy-5′-methylphenyl)-benzotriazole, 2-(3′,5′-di-tert-butyl-2′-hydroxyphenyl)-5-chlorobenzotriazole, 2(2′-hydroxy-3′,5′-di-tert-amylphenyl)benzotriazole, benzenepropanoic acid, 3-(2H-benzotriazol-2-yl)-5-(1,1-dimethylethyl)-4-hydroxy-,C7-9-branched alkyl esters, 2-(3′,5′-bis(1-methyl-1-phenylethyl)-2′-hydroxyphenyl)benzotriazole, 2-(2-hydroxy-3-dimethylbenzylphenyl-5-(1,1,3,3-tetramethylbutyl))-2H-benzotriazole, iso-octyl-3-(3-(2H-benzotriazol-2-yl)-5-tert-butyl-) 4-hydroxyphenyl-proprionate, and poly(oxy-1,2-ethanediyl), α-(3-(3-(2H-benzotriazol-2-yl)-5-(1,1-dimethylethyl)-4-hydroxyphenyl)-1-oxopropyl)-ω-hydroxy poly(oxy-1,2-ethanediyl), α-(3-(3-(2H-benzotriazol-2-yl)-5-(1,1-dimethylethyl)-4-hydroxyphenyl)-1-oxopropyl)-ω-(3-(3-(2H-benzotriazol-2-yl)-5-(1,1-dimethylethyl)-4-hydroxyphenyl)-1-oxopropyl). A preferred benzotriazole UV absorber includes 2(2′-hydroxy-3′5′-di-tert-amylphenyl)benzotriazole. Commercially available benzotriazole compositions are sold by Ciba Specialty Additives under the designation Tinuvin.

Suitable triazine UV absorbers include 2-(4-(2-hydroxy-3-tridecyl oxypropyl)oxy)-2-hydroxyphenyl)-4,6-bis (2,4,dimethylphenyl)-1,3,5-triazine, 2-(4-(2-hydroxy-3-dodecyl oxypropyl)oxy)-2-hydroxyphenyl)-4,6-bis(2,4-dimethylphenyl)-1,3,5-triazine, and 2-(4-(2-hydroxy-3-(2′-ethyl)hexyl)oxy)-2-hydroxyphenyl)-4,6-bis(2,4-dimethylphenyl)-1,3,5-triazine. Preferred triazine UV absorbers include a mixture of 2-(4-(2-hydroxy-3-tridecyl oxypropyl)oxy)-2-hydroxyphenyl)-4,6-bis (2,4,dimethylphenyl)-1,3,5-triazine and 2-(4-(2-hydroxy-3-dodecyl oxypropyl)oxy)-2-hydroxyphenyl)-4,6-bis(2,4-dimethylphenyl)-1,3,5-triazine.

The UV absorber may be provided in a suitable carrier, such as water or an organic solvent. Typical organic solvents include ketones, acetates, esters, glycol ethers, aliphatic hydrocarbons and aromatic hydrocarbons. The UV absorber may comprise from about 0.05 to about 20 weight percent of the overall coating composition, typically from about 0.5 to about 2 weight percent. The aqueous or organic solvent may comprise from zero to about 99 weight percent of the overall coating composition, typically from zero to about 95 weight percent.

The coating compositions of the present invention may also comprise any suitable thermoplastic or thermoset binder such as polyurethanes, acrylics, polyesters, polyureas, polysiloxanes, polyethers, polycarbonates, polyamides, epoxies, vinyls, ethylenically unsaturated compounds, thiolenes and the like. The binder may be present in the coating in an amount up to about 99 weight percent. Examples of polymers useful in forming the binder may include hydroxyl or carboxylic acid-containing acrylic copolymers, hydroxyl or carboxylic acid-containing polyester polymers, oligomers and isocyanate, acid or hydroxyl-containing polyurethane polymers, and amine, acid or isocyanate-containing polyureas. Some binders that may be suitable for use in the present coating compositions are described in U.S. Pat. No. 5,939,491, which is incorporated by reference herein. In one embodiment, the binder specifically excludes a hydrophilic polysaccharides, vinyl polymers, formaldehyde resins, ionic polymers, latex polymers, maleic anhydride/acid-containing polymers, acrylamide-containing polymers, and/or poly(alkylene imine).

In an embodiment of the present invention, the protective coating may further comprise at least one light stabilizer in amounts of from about 0.05 to about 10 weight percent of the overall coating composition, typically from about 0.2 to about 2 weight percent.

Suitable light stabilizers include decanedioic acid, bis(2,2,6,6-tetramethyl-4-piperidinyl)ester, reaction products with 1,1-dimethylethyl-hydroperoxide and octane, bis(1,2,2,6,6-pentamethyl-4-piperidinyl)(3,5-di-tert-butyl-4-hydroxybenxyl)butylpropanedioate, bis(1,2,2,6,6 pentamethyl-4-piperidinyl)sebacate methyl 1,2,2,6,6-pentamethyl-4-piperidinyl sebacate, and blends of butanedioic acid polymer with (4-hydroxy-2,2,6,6-tetramethylpiperidin-1-yl) ethanol and N,N′,N″,N′″-tetrakis(4,6-bis(butyl-(N-methyl-2,2,6,6-tetramethylpiperidine-4-yl)amino)triazine-2-yl-4,7-diazadecane-1,10-diamine, with bis(1,2,2,6,6 pentamethyl-4-piperidinyl)sebacate methyl 1,2,2,6,6-pentamethyl-4-piperidinyl sebacate being preferred for many applications. Hindered amine light stabilizers (HALS) may be used. HALS are commercially available from, for example, Ciba Specialty Additives under the designation Tinuvin.

In addition to the above-noted UV absorbers, binders and light stabilizers, the protective coating compositions may optionally include other ingredients such as free radical scavengers, antioxidants, sterically hindered phenols, phosphates, pigments, cross-linkers. initiators, dye fixatives, wetting and flow agents, slip and mar additives, solvents, reactive diluents and defoamers.

Suitable antioxidants include tetrakis(methylene(3,5-di-tert-butyl-4-hydroxyhydrocinnamate))methane, thiodiethylene bis(3,5-di-tert-butyl-4-hydroxyhydrocinnamate), and octadecyl 3,5-di-tert-butyl-4-hydroxyhydrocinnamate.

Suitable pigments include standard paint pigments such as titanium dioxide, talc, clay, silica, carbon black, yellow iron oxide and organic pigments such as quinacridone red, phthalo blue and the like.

Suitable curing agents or cross-linkers include polyepoxides, polyacids, polyols, anhydrides, polyamines, aminoplasts, phenoplasts, carbodiimides, formaldehydes and isocyanates. The appropriate cross-linker can be selected by one skilled in the art depending on the binder used. When a cross-linker is used, it is generally present in an amount of up to about 50 weight percent, based on the total solid weight of the cured binder. Some cross-linkers that may be suitable for the present resins are described in the U.S. Pat. No. 5,939,491 . Combinations of cross-linkers can be used.

The cross-linkers may be activated upon application of the coating composition to the microporous sheet. Standard curing procedures may be used, for example, UV curing, heating curing and the like. Alternatively, the cross-linkers may be activated during subsequent operations, such as lamination or molding, e.g., where the elevated temperatures experienced during such operations are used to activate the cross-linkers. In this case, the cross-linkers may be partially activated upon application to the microporous sheet, and fully cross-linked during subsequent treatment at elevated temperatures or UV exposure. Cross-linking may occur after subsequent printing or coating operations.

The microporous sheets coated in accordance with the present invention may comprise a synthetic polymer matrix and an interconnecting network of pores. The microporous sheet may further comprise filler particles. The matrix of the microporous sheet may comprise substantially water-insoluble thermoplastic organic polymer. Many kinds of such polymers are suitable for use as the matrix of the microporous sheet. In general, any substantially water-insoluble thermoplastic organic polymer which can be extruded, calendered, pressed or rolled into film, sheet, strip or web may be used. The polymer may be a single polymer or it may be a mixture of polymers. Some examples of suitable polymers include polyesters, vinyls, polystyrenes, polyethylenes and oriented polypropylenes. The polymers may be homopolymers, copolymers, random copolymers, block copolymers, graft copolymers, atactic polymers, isotactic polymers, syndiotactic polymers, linear polymers or branched polymers. When mixtures of polymers are used, the mixture may be homogeneous or it may comprise two or more polymeric phases.

Examples of classes of suitable substantially water-insoluble thermoplastic organic polymers include the thermoplastic polyolefins, poly(halo-substituted olefins), polyesters, polyamides, polyurethanes, polyureas, poly(vinyl halides), poly(vinylidene halides), polystyrenes, poly(vinyl esters), polycarbonates, polyethers, polysulfides, polyimides, polysilanes, polysiloxanes, polycaprolactones, polyacrylates, and polymethacrylates. Hybrid classes, for example, thermoplastic poly(urethane-ureas), poly(ester-amides), poly(silane-siloxanes), and poly(ether-esters) are within contemplation. Examples of specific substantially water-insoluble thermoplastic organic polymers include thermoplastic high density polyethylene, low density polyethylene, ultrahigh molecular weight polyethylene, polypropylene (atactic, isotactic, or syndiotactic), poly(vinyl chloride), polytetrafluoroethylene, copolymers of ethylene and acrylic acid, copolymers of ethylene and methacrylic acid, poly(vinylidene chloride), copolymers of vinylidene chloride and vinyl acetate, copolymers of vinylidene chloride and vinyl chloride, copolymers of ethylene and propylene, copolymers of ethylene and butene, poly(vinyl acetate), polystyrene, poly(omega-aminoundecanoic acid) poly(hexamethylene adipamide), poly(epsilon-caprolactam), and poly(methyl methacrylate).

The present microporous sheets can also comprise finely divided, substantially water-insoluble particulate filler, which may comprise, for example, siliceous and/or non-siliceous particles. The filler particles, when used, will typically comprise at least 30 or 40 weight percent of the microporous material up to about 70 or 80 weight percent. In one embodiment, the filler particles are the predominant component of the sheet in comparison with the polymer matrix on a weight percent basis. Thus, the filler particles may comprise greater than 50 weight percent of the combined total of the polymer matrix and filler particles. For example, the filler particles may comprise greater than 60 weight percent.

A preferred particulate filler is finely divided substantially water-insoluble siliceous particles. Examples of suitable siliceous particles include particles of silica, mica, montmorillonite, kaolinite, asbestos, talc, diatomaceous earth, vermiculite, natural and synthetic zeolites, cement, calcium silicate, aluminum silicate, sodium aluminum silicate, aluminum polysilicate, alumina silica gels, and glass particles. Of the silicas, precipitated silica, silica gel or fumed silica may be particularly suitable.

Examples of non-siliceous filler particles include particles of titanium oxide, zinc oxide, antimony oxide, zirconia, magnesia, alumina, zinc sulfide, barium sulfate, strontium sulfate, calcium carbonate, magnesium carbonate, magnesium hydroxide, and finely divided substantially water-insoluble flame retardant filler particles such as particles of ethylenebis(tetra-bromophthalimide), octabromodiphenyl oxide, decabromodiphenyl oxide, and ethylenebisdibromonorbornane dicarboximide.

The filler particles typically have an average particle size of less than 40 micrometers. In the case of precipitated silica, the average ultimate particle size (irrespective of whether or not the ultimate particles are agglomerated) may be less than 0.1 micrometer.

Minor amounts, usually less than 5 percent by weight, of other materials used in processing such as lubricant, processing plasticizer, organic extraction liquid, water and the like may optionally also be present. Additional materials introduced for particular purposes may optionally be present in the microporous material in small amounts, usually less than 15 percent by weight. Examples of such materials include antioxidants, ultraviolet light absorbers, reinforcing fibers such as chopped glass fiber strand and the like.

The microporous sheets may also comprise a network of interconnecting pores which communicate substantially throughout the material. On a coating-free basis, the pores typically constitute from 30 to 95 volume percent of the microporous material. For example, the pores may constitute from 60 to 75 percent by volume of the microporous material. On a coating-free basis, the volume average diameter of the pores may be at least 0.02 micrometers, typically at least 0.04 micrometers. The volume average diameter of the pores is also typically less than 0.5 micrometers.

Some examples of microporous sheets are disclosed in U.S. Pat. Nos. 4,833,172; 4,861,644 and 6,114,023, which are incorporated herein by reference. Commercially available microporous printing sheets are sold under the designation Teslin® by PPG Industries, Inc.

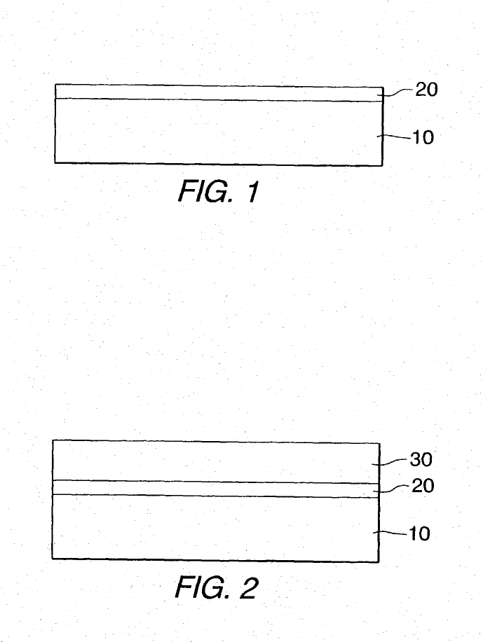

FIG. 1 illustrates a microporous sheet 10 with a protective coating 20. Although the protective coating 20 is shown as a continuous layer on the surface of the sheet 10 in FIG. 1, at least a portion of the protective coating 20 may penetrate into the microporous sheet 10. In one embodiment, the protective coating does not completely fill the pores of the microporous sheet, such that the interconnected pore structure is maintained throughout at least a portion of the sheet. When the coating 20 penetrates into the pores of the microporous sheet 10, it preferably coats at least a portion of the polymer matrix of the sheet.

Although the protective coating 20 shown in FIG. 1 is applied directly to the microporous sheet 10, other layers may optionally be provided between the layers. For example, primers, inks and sealer layers may be applied between the microporous sheet 10 and the protective coating 20.

FIG. 2 illustrates a microporous sheet 10 with a coating 20 and an additional layer 30. The layer 30 may comprise ink, sealer, color coat, opaque layer, topcoat or the like, depending upon the particular application.

The protective coatings may be applied to the microporous sheets by any suitable technique such as spraying, rolling, dipping, brushing and the like. The coatings are applied in the form of a flowable material, e.g., liquid, powder, spray or the like. The protective coating may have any desired dry film thickness, typically from about 5 to about 100 microns.

### EXAMPLES

The following examples are intended to illustrate the invention, and should not be construed as limiting the invention in any way.

### Example 1

Compositions were made using the components and weight percents shown in Table I. The components were added and mixed using propeller blade agitation with sufficient speed to make a vortex and with agitation following for several minutes to disperse the components uniformly in the coating.

TABLE I

| Description | Coating A | Coating B |
|---|---|---|
| Urethane acrylate oligomer¹ | 51.90 | 52.40 |
| Neopentyl glycol propoxylate | 31.90 | 32.90 |
| diacrylate² | | |
| Ethoxyethoxyethyl acrylate³ | 5.00 | 5.00 |
| Isodecyl acrylate⁴ | 5.00 | 5.00 |
| IRGACURE 819⁵ | 1.50 | 1.50 |
| DAROCUR 1173⁶ | 1.50 | 1.50 |
| NALCO 2301⁷ | 0.50 | 0.50 |
| POLYSILK 750⁸ | 1.00 | 1.00 |
| Q4-3667⁹ | 0.25 | 0.25 |
| FC-431 fluorocarbon¹⁰ | 0.03 | 0.03 |
| TINUVIN 400¹¹ | 1.00 | |
| TINUVIN 292¹² | 0.50 | |

¹Aliphatic urethane acrylate oligomer resin.
²Photomer 4127 from Cognis Corporation.
³SR 256 from Sartomer Company.
⁴SR 395 from Sartomer Company.
⁵Photoinitiator from Ciba Specialty Chemicals.
⁶Photoinitiator from Ciba Specialty Chemicals.
⁷Defoamer from Ondea Nalco.
⁸Modified polyethylene wax from Micro Powders, Inc.
⁹Silicon fluid from Dow Corning Corp.
¹⁰Fluorochemical polymer from 3M.
¹¹UV light absorber from Ciba Specialty Chemicals.
¹²Hindered amine light stabilizer from Ciba Specialty Chemicals.

Coating A was drawn down over microporous sheets using a wire wound applicator bar to apply about 10 microns of coating. The coating was cured by exposure to 200 mJ/cm² using 80 W/cm medium pressure mercury UV curing lamps. A second coat of Coating A was drawn down using the same procedure and similarly cured except that the exposure was in an inert atmosphere. Coating A was applied to Teslin® microporous sheets to make Samples 7 and 10 as described in Table II. For Sample 10 of Table II, Coating A was applied over microporous sheet that had an opaque ink printed on part of the surface.

Coating B was applied and cured using the same procedure as described above for Coating A. Coating B was applied to a Teslin® microporous sheet to make Sample 8 as described in Table II.

### Example 2

Coating C was prepared by mixing an acrylic resin binder, benzotriazole UV absorber and hindered light stabilizer, with a DCX 61 isocyanate hardener, and a DT 870 solvent in a 4:1:1 volume blend and stirred by hand with a spatula to uniformly disperse the components. The coating is commercially available as a two-pack polyurethane clearcoat sold under the designation DCU 2042 by PPG Industries. The coating was applied to a Teslin® microporous sheet using atomized air and hand spray application. Dry film thickness was approximately 50 microns. For Sample 9 in Table II, Coating C was flashed and cured for at least 72 hours at ambient temperature. For Sample 11 in Table II, Coating C was applied over a Teslin® microporous sheet that had opaque ink printed on part of the surface, and the flash and cure times were 4 hours at ambient temperature and 1 hour at 60° C.

### Example 3

Teslin® microporous sheets were exposed to accelerated weathering conditions using a QUV test apparatus controlled as per ASTM G53 but with a cycle of 8 hours of UV at 70° C. and 4 hours of condensation at 50° C. Sheets were observed for changes in appearance or ductility. Failure was defined as observations that the sheet or coated sheet was grossly embrittled. Indications of a grossly embrittled sheet may include observations of severe chalking, cracking, fracturing, friability or extreme loss of ductility. Table II describes the hours to failure for each sheet. The samples were checked at increments of approximately 250 hours. The approximate hours to embrittlement values listed in Table II indicate that embrittlement occurred within the 250 hour increment prior to the listed time. Samples 1 to 6 in Table II are Teslin® microporous sheet commercially available from PPG Industries which did not have a protective coating of the present invention. For Samples 6, 10, and 11 the Teslin®) microporous sheet had an opaque ink applied over part of the surface. Samples 6 to 11 in Table II are Teslin® microporous sheets coated with Coating A, Coating B or Coating C.

TABLE II

| | | | Approximate | Hours to |
|---|---|---|---|---|
| | | | hours | embrittlement |
| | | | to | over |
| Sample | Teslin ® | Coating | embrittlement | printed areas |
| Sample 1 | SP700 | NONE | 250 | Not applicable |
| Sample 2 | SP1000 | NONE | 250 | Not applicable |
| Sample 3 | TS1000 | NONE | 250 | Not applicable |
| Sample 4 | ED1000 | NONE | 500 | Not applicable |
| Sample 5 | ED1200 | NONE | 750 | Not applicable |
| Sample 6 | ED1200 | NONE | 750 | 1000 |
| | with printed | | | |
| | areas | | | |
| Sample 7 | SP 1000 | Coating A | 500 | Not applicable |
| Sample 8 | SP 1000 | Coating B | 250 | Not applicable |
| Sample 9 | SP 1000 | Coating C | 2000 | Not applicable |
| Sample 10 | ED1200 | Coating A | >2000 | >2000 |
| | with printed | | | |
| | areas | | | |
| Sample 11 | ED1200 | Coating C | >2000 | >2000 |
| | with printed | | | |
| | areas | | | |

As can be seen from the results presented in Table II. Samples 1, 2, 3 and 8 gave the worst performance in terms of hours of exposure to failure. Samples 1, 2 and 8 all utilized synthetic printing (SP) grade Teslin® microporous sheet not specifically modified for durability. Sample 3 utilized thermally stabilized (TS) microporous sheet. Sample 8 demonstrates that there is no improvement in terms of hours of exposure to failure with Coating B applied to the microporous sheet.

Sample 7 demonstrates improvement in terms of hours of exposure to failure. A comparison of Sample 7 with Sample 8 demonstrates improvement when the coating contains a UV absorber and a light stabilizer.

Samples 4 and 5 each utilized extended durability (ED) grade Teslin® microporous sheet. As compared with Samples 1, 2, 3 and 8, the hours of exposure to failure was improved for Samples 4 and 5. Sample 6 demonstrates improvement in terms of hours of exposure to failure when the sheet is printed with opaque material such as an ink.

Sample 9 demonstrates improvement in terms of hours of exposure to embrittlement with Coating C applied to the microporous sheet. Samples 10 and 11 demonstrate improvements with Coating A or Coating C over exterior durable grade microporous sheets. Samples 9 and 10 further demonstrate improvements with Coating A or Coating C over opaque ink printed microporous sheet.

Whereas particular embodiments of this invention have been described above for purposes of illustration, it will be evident to those skilled in the art that numerous variations of the details of the present invention may be made without departing from the invention as defined in the appended claims.

What is claimed is:

1. A microporous sheet coated with a protective coating comprising a UV absorber and a binder, wherein the binder comprises a polyurethane acrylic, polyurea, polysiloxane, polyester, polyether, polycarbonate, polyamide, epoxy vinyl and/or thiolene.

2. The microporous sheet of claim 1, wherein the UV absorber comprises a benzotriazole, triazine, oxanilide and/or benzophenone.

3. The microporous sheet of claim 1, wherein the UV absorber comprises benzotriazole.

4. The microporous sheet of claim 1, wherein the UV absorber comprises 2-(2′-hydroxy-5′-methylphenyl)-benzotriazole, 2-(3′,5′-di-tert-butyl-2′-hydroxyphenyl)-5-chlorobenzotriazole, 2(2′-hydroxy-3′,5′-di-tert-amylphenyl)benzotriazole, benzenepropanoic acid, 3-(2H-benzotriazol-2-yl)-5-(1,1-dimethylethyl)-4-hydroxy-,C7-9-branched alkyl esters, 2-(3′,5′-bis(1-methyl-1-phenylethyl)-2′-hydroxyphenyl)benzotriazole, 2-(2-hydroxy-3-dimethylbenzylphenyl-5-(1,1,3,3-tetramethylbutyl))-2H-benzotriazole, iso-octyl-3-(3-(2H-benzotriazol-2-yl)-5-tert-butyl-)4-hydroxyphenyl-proprionate, and/or poly(oxy-1,2-ethanediyl), α-(3-(3-(2H-benzotriazol-2-yl)-5-(1,1-dimethylethyl)-4-hydroxyphenyl)- 1-oxopropyl)-ω-hydroxy poly(oxy-1,2-ethanedlyl), α-(3-(3-(2H-benzotriazol-2-yl)-5-(1,1-dimethylethyl)-4-hydroxyphenyl)-1-oxopropyl)-ω-(3-(3-(2H-benzotriazol-2-yl)-5-(1,1-dimethylethyl)-4-hydroxyphenyl)-1-oxopropyl).

5. The microporous sheet of claim 1, wherein the UV absorber comprises triazine.

6. The microporous sheet of claim 1, wherein the protective coating comprises 2-(4-(2-hydroxy-3-tridecyl oxypropyl)oxy)-2-hydroxyphenyl)-4,6-bis (2,4,dimethylphenyl)-1,3,5-triazine, 2-(4-(2-hydroxy-3-dodecyl oxypropyl)oxy)-2-hydroxyphenyl)-4,6-bis(2,4-dimethylphenyl)-1,3,5-triazine, and/or 2-(4-(2-hydroxy-3-(2′-ethyl)hexyl)oxy)-2-hydroxyphenyl)-4,6-bis(2,4-dimethylphenyl)-1,3,5-triazine.

7. The microporous sheet of claim 1, wherein the UV absorber comprises from about 0.05 to about 20 weight percent of the protective coating.

8. The microporous sheet of claim 1, wherein the UV absorber comprises from about 0.5 to about 2 weight percent of the protective coating.

9. The microporous sheet of claim 9, wherein the binder comprises a polyurethane.

10. The microporous sheet of claim 9, wherein the protective coating further comprises a crosslinker.

11. The microporous sheet of claim 1, wherein the protective coating further comprises a light stabilizer.

12. The microporous sheet of claim 11, wherein the light stabilizer comprises a hindered amine.

13. The microporous sheet of claim 11, wherein the light stabilizer comprises decanedioic acid, bis(2,2,6,6-tetramethyl-4-piperidinyl)ester, reaction products with 1,1-dimethylethyl-hydroperoxide and octane, bis(1,2,2,6,6-pentamethyl-4-piperidinyl)(3,5-di-tert-butyl-4-hydroxybenxyl)butylpropanedioate, bis(1,2,2,6,6 pentamethyl-4-piperidinyl)sebacate methyl 1,2,2,6,6-pentamethyl-4-piperidinyl sebacate, and/or blends of butanedioic acid polymer with (4-hydroxy-2,2,6,6-tetramethylpiperidin-1-yl) ethanol and N,N′,N″,N′″-tetrakis(4,6-bis(butyl-(N-methyl-2,2,6,6-tetramethylpiperidine-4-yl)amino)triazine-2-yl-4,7-diazadecane-1,10-diamine.

14. The microporous sheet of claim 11, wherein the light stabilizer comprises from about 0.05 to about 10 weight percent of the protective coating.

15. The microporous sheet of claim 1, wherein the protective coating further comprises an antioxidant.

16. The microporous sheet of claim 1, wherein the protective coating further comprises a pigment.

17. The microporous sheet of claim 1, wherein the microporous sheet comprises a synthetic polymer matrix.

18. The microporous sheet of claim 17, wherein the microporous sheet further comprises at least about 30 weight percent filler particles.

19. The microporous sheet of claim 18, wherein the filler particles comprise at least 50 weight percent of the microporous sheet.

20. The microporous sheet of claim 1, wherein the microporous sheet comprises a polyethylene matrix.

21. The microporous sheet of claim 1, wherein the microporous sheet comprises silica filler particles.

22. The microporous sheet of claim 1, wherein the microporous sheet comprises from about 30 to about 95 volume percent pores.

23. The microporous sheet of claim 1, wherein the protective coating has a dry film thickness of from about 5 to about 100 microns.

24. The microporous sheet of claim 1, wherein the coated microporous sheet has a QUV resistance of at least 500 hours.

25. The microporous sheet of claim 1, wherein the coated microporous sheet has a QUV resistance of at least 750 hours.

26. The microporous sheet of claim 1, wherein the coated microporous sheet has a QUV resistance of greater than 1,000 hours.

27. The microporous sheet of claim 26, wherein the microporous sheet comprises a synthetic polymer matrix and filler particles.

28. A method of coating a microporous sheet, the method comprising applying a flowable UV absorbing protective coating on the microporous sheet, wherein the coating comprises a polyurethane acrylic, polyurea, polysiloxane, polyester, polyether, polycarbonate, polyamide, epoxy vinyl and/or thiolene.

29. The method of claim 28, wherein the protective coating is applied by spraying, rolling, dipping or brushing.

30. The method of claim 28, wherein the protective coating is applied at a dry film thickness of from about 5 to about 100 microns.

31. The method of claim 28, further comprising curing the protective coating after it is applied on the microporous sheet.

32. The method of claim 31, wherein the protective coating is UV cured.

33. The method of claim 31, wherein the protective coating is cured by heating.

34. The method of claim 28, wherein the UV absorber comprises a benzotriazole, triazine, oxanilide and/or benzophenone.

35. The method of claim 28, wherein the protective coating further comprises a binder.

36. The method of claim 28, wherein the protective coating further comprises a light stabilizer.

37. The method of claim 28, wherein the protective coating further comprises a pigment.

38. The method of claim 28, wherein the microporous sheet comprises a synthetic polymer matrix and filler particles.
